(19) United States
(12) Patent Application Publication
(10) Pub. No.: US 2007/0267582 A1
(43) Pub. Date: Nov. 22, 2007

(54) SUBSTRATE EDGE EXPOSURE APPARATUS

(76) Inventor: Yukihiko Inagaki, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/692,410

(22) Filed: Mar. 28, 2007

(30) Foreign Application Priority Data
Mar. 28, 2006 (JP) JP2006-087544

(51) Int. Cl. G21K 5/00

(52) U.S. Cl. 250/492.22

(57) ABSTRACT

Prior to edge exposure, the type of a photo resist that has been coated on a semiconductor wafer is identified. Then, the sensitivity of this resist is determined based on the information of the identified resist type. Based on the determined resist sensitivity, a laser output from a semiconductor laser light source, and a wafer rotation speed attained by a wafer rotating part are determined, and the edge exposure is then performed in accordance with these determined values. Thus, both of the laser output and the wafer rotation speed can be determined based on the resist sensitivity, and the edge exposure can be advanced in accordance with these values. It is therefore capable of flexibly coping with the sensitivity of the resist used.

### BACKGROUND OF THE INVENTION

1. Field of the Invention

The present invention relates to a substrate edge exposure apparatus that exposes the edge of a semiconductor substrate, a glass substrate for a liquid crystal display device, a glass substrate for a photo mask, a substrate for an optical disk, or the like (hereinafter referred to simply as a “substrate”), on which a photo resist (hereinafter referred to simply as a “resist”) has been coated.

2. Description of the Background Art

Products such as semiconductor devices and liquid crystal displays can be manufactured by subjecting the above-mentioned substrates to a series of processes such as cleaning, resist coating, exposure, development, etching, formation of inter layer dielectrics, heat treatment, and dicing. The resist coating process is the process of dropping a resist solution on a main surface of the substrate rotating, in order to spread it by centrifugal force in a thin resist film over the main surface of the substrate. This resist coating process enables the resist film to be formed substantially uniformly over the entire surface of the substrate. However, the edge of the main surface of the substrate is not subjected to pattern exposure, and hence the resist film is unnecessary. The edge of the main surface of the substrate is brought into contact with the arm of a transport robot when transporting the substrate. The presence of the unnecessary resist film might cause dust. Consequently, for example, Japanese Patent Application Laid-Open No. 9-326358 discloses the technique of exposing the resist of the edge by introducing the light (usually ultra violet) from a light source, such as a mercury xenon lamp, to an exposure head through an optical fiber, and irradiating the light from the exposure head to the edge of the main surface of the substrate.

However, the mercury xenon lamp has a relatively short lamp life, and hence it is necessary to change the lamp frequently. This results in not only poor maintenance property but also high running cost. Consequently, for example, Japanese Patent Application Laid-Open No. 2003-68605 discloses an apparatus for exposing the edge of a substrate by using laser light.

Recently, as the miniaturization of design rules is advanced, the light source used for pattern exposure has a shorter wavelength, namely changing from conventional ultra violet light sources (so-called g-line light source and i-line light source) to a KrF excimer laser light source, or an ArF excimer laser light source, or further to an F2 light source. Since the KrF light source and the succeeding ones are low in light intensity, there has been used a chemically amplified resist to which a post-exposure baking is essential, and various types of resists have been used. There are various types of resists, such as ones of superior sensitivity and ones of poor sensitivity. With the conventional edge exposure apparatuses, no automatic adjustment to processing conditions has been made in accordance with the resist sensitivity. Therefore, when using a resist of poor sensitivity, the operator of the apparatus reduces the rotational frequency of the substrate. This may increase the processing time required for edge exposure, and decrease the throughput of a series of photolithography processes using the resists.

### SUMMARY OF THE INVENTION

The present invention is directed to a substrate edge exposure apparatus that exposes the edge of a substrate on which a photo resist has been coated.

According to the present invention, a substrate edge exposure apparatus includes: a holding and rotating part for holding and rotating a substrate in a substantially horizontal plane; a semiconductor laser light source for irradiating a laser light to an edge of the substrate rotated by the holding and rotating part; a processing condition determining part for determining, based on a sensitivity of a photo resist coated on the substrate, a laser output from the semiconductor laser light source and a substrate rotation speed attained by the holding and rotating part; a rotation control part for controlling the holding and rotating part so that the substrate can be rotated at the substrate rotation speed determined by the processing condition determining part; and an output control part for controlling the semiconductor laser light source so that a laser light can be emitted according to the laser output determined by the processing condition determining part.

It is capable of flexibly coping with the sensitivity of a photo resist used, because the laser output from the semiconductor laser light source and the substrate rotation speed attained by the holding and rotating part are determined based on the sensitivity of the photo resist coated on the substrate.

Preferably, the processing condition determining part determines a laser output from the semiconductor laser light source and a substrate rotation speed attained by the holding and rotating part, so that the process can be completed within a preset edge exposure time.

This further prevents throughput from lowering than conventional art.

According to an aspect of the present invention, a substrate edge exposure apparatus includes: a holding and rotating part for holding and rotating a substrate in a substantially horizontal plane; a light emitting diode light source for irradiating a light to an edge of the substrate rotated by the holding and rotating part; a processing condition determining part for determining, based on a sensitivity of a photo resist coated on the substrate, a light output from the light emitting diode light source and a substrate rotation speed attained by the holding and rotating part; a rotation control part for controlling the holding and rotating part so that the substrate can be rotated at the substrate rotation speed determined by the processing condition determining part; and an output control part for controlling the light emitting diode light source so that a light can be emitted according to the light output determined by the processing condition determining part.

It is capable of flexibly coping with the sensitivity of a photo resist used, because the light output from the light emitting diode light source and the substrate rotation speed attained by the holding and rotating part are determined based on the sensitivity of the photo resist coated on the substrate.

Accordingly, an object of the present invention is to provide a substrate edge exposure apparatus capable of flexibly coping with the sensitivity of a photo resist to be used.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view illustrating an example of a substrate edge exposure apparatus according to the present invention;

FIG. 2 is a diagram illustrating the configuration of a key part of an exposure part;

FIG. 3 is a block diagram illustrating a control mechanism of the substrate edge exposure apparatus;

FIG. 4 is a flow chart illustrating the operation procedure in the substrate edge exposure apparatus; and

FIG. 5 is a diagram illustrating an exposure part of a substrate edge exposure apparatus according to a second preferred embodiment of the present invention.

### DESCRIPTION OF THE PREFERRED EMBODIMENTS

Preferred embodiments of the present invention will be described below in detail with reference to the accompanying drawings.

### 1. First Preferred Embodiment

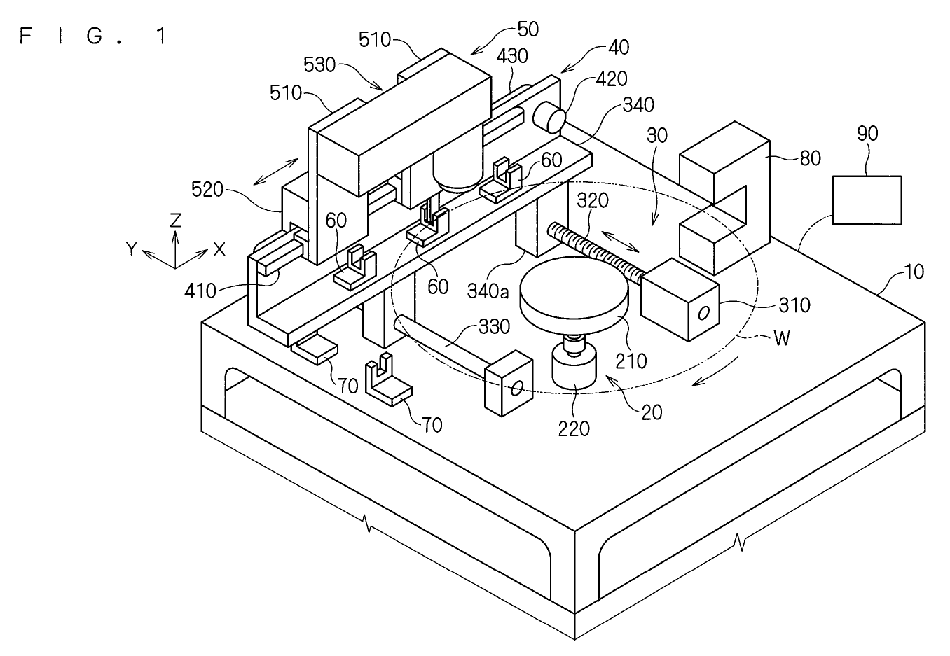

FIG. 1 is a perspective view illustrating an example of a substrate edge exposure apparatus according to the present invention. FIG. 1 is accompanied by an XYZ rectangular coordinate system, where the Z-axis direction is a vertical direction, and an XY plane is a horizontal plane. Referring to FIG. 1, the mechanism configuration of the substrate edge exposure apparatus will be described below.

This substrate edge exposure apparatus is suitable for exposing the edge of a main surface of a semiconductor wafer W on which a photo resist film (preferably, a chemically amplified resist film) has been formed. The apparatus is provided with a base 10, a wafer rotating part 20, a Y-axis driving part 30, an X-axis driving part 40, an exposure part 50, an X-axis sensor 60, a Y-axis sensor 70, an edge sensor 80, and a controller 90.

In the wafer rotating part 20, a vacuum chuck 210 adsorbs and holds the semiconductor wafer W in its substantially horizontal position. With a vertical axis (the Z-axis) direction as a rotation axis, the semiconductor wafer W is rotated therearound in a θ-direction by the drive of a rotary motor (a θ-axis motor) 220.

The Y-axis driving part 30 is a driving mechanism to translate the exposure part 50 in the Y-axis direction. The Y-axis driving part 30 is provided with a Y-axis motor 310 fixed to the base 10, a Y-axis ball screw 320 connected to the rotational axis thereof, a Y-axis linear guide 330, and a Y-axis base 340 which is slidably mounted on the Y-axis linear guide 330, and translated by the Y-axis ball screw 320.

The X-axis driving part 40 is a driving mechanism to translate the exposure part 50 in the X-axis direction. The X-axis driving part 40 is a driving mechanism in the X-axis direction, which has an X-axis linear guide 410 disposed along the X-axis direction at the Y-axis base 340 of the Y-axis driving part 30, an X-axis motor 420, and a timing belt 430 hung on the rotation shaft of the X-axis motor 420 and disposed along the X-axis direction.

The exposure part 50 is provided with an exposure base 510 slidably mounted on the X-axis liner guide 410 of the X-axis driving part 40, a driving force transmitting member 520 which is connected to the timing belt 430 and transmits its driving force to the exposure base 510, and an exposure head 530 disposed at the exposure base 510. The exposure part 50 irradiates light onto the semiconductor wafer W so as to expose the edge of the main surface thereof. The exposure head 530 of the first preferred embodiment irradiates a laser light emitted from a semiconductor laser element, and its configuration will be further described later.

The X-axis sensor 60 is a photo sensor that a light emitting element and a light receiving element are oppositely disposed on the Y-axis base 340, and detects the location of the exposure part 50 in the X-axis direction. The spacing between the light emitting element and the light receiving element allows the passage of a projection (not shown) disposed at a lower end of the exposure base 510 of the exposure part 50. Sensing the passage situation thereof enables detection of the location of the exposure part 50 (strictly speaking, the exposure base 510) in the X-axis direction.

The Y-axis sensor 70 has the same photo sensor as the X-axis sensor 60 on the base 10, and detects the location of the exposure part 50 in the Y-axis direction. The Y-axis sensor 70 detects the location of the exposure part 50 (strictly speaking, the Y-axis base 340) in the Y-axis direction by sensing the projection provided on the lower surface of the Y-axis base 340.

The edge sensor 80 is also the same photo sensor as the X-axis sensor 60 and the Y-axis sensor 70, and has a light emitting element and a light receiving element which are arranged so as to pinch from above and below the semiconductor wafer W held on the vacuum chuck 210 of the wafer rotating part 20. The edge sensor 80 detects the orientation flat or notch of the semiconductor wafer W, and detects the eccentric amount of the semiconductor wafer W with respect to the rotation shaft of the wafer rotating part 20.

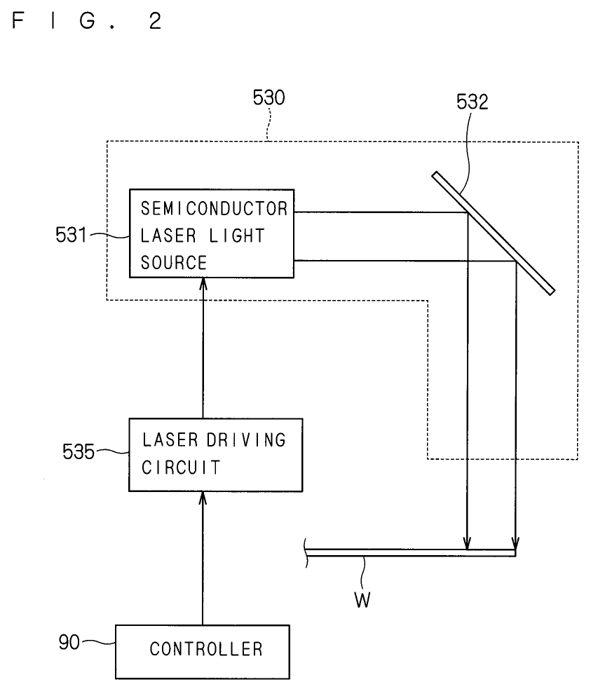

FIG. 2 is a diagram illustrating the configuration of a key part of the exposure part 50. A semiconductor laser light source 531 and a reflector 532 are provided at the exposure head 530 of the exposure part 50. In the first preferred embodiment, the semiconductor laser light source 531 has a single semiconductor laser element (a laser diode). The semiconductor laser element has the characteristic features of a smaller size, higher efficiency, a lower voltage, lower power consumption, and a longer life than other types of lasers. In the first preferred embodiment, a single laser light can be emitted from the semiconductor laser light source 531 because the semiconductor laser light source 531 has the single semiconductor laser element.

The laser light emitted from the semiconductor laser light source 531 is reflected from the reflector 532, and then irradiated from the exposure head 530 to the edge of the semiconductor wafer W. Since the laser light has extremely high directivity and will not spread, the exposure head 530 in the first preferred embodiment has no special lens system for condensing light.

The exposure part 50 is further provided with a laser driving circuit 535 for driving the semiconductor laser element. On the receipt of an instruction from the controller 90, the laser driving circuit 535 controls the ON/OFF of a laser light emission from the semiconductor laser light source 531, and also controls the output of the laser light. Alternatively, the laser driving circuit 535 may be disposed in the inside of the exposure head 530.

The semiconductor laser light source 531 housing the semiconductor laser element eliminates the necessity for arranging an optical fiber performing optical transmission in the exposure head 530, and also eliminates the necessity for a conventional shutter because the electrical control from the laser driving circuit 535 enables the ON/OFF of the laser light emission. Hence, the size of the exposure head 530 can be reduced to save space.

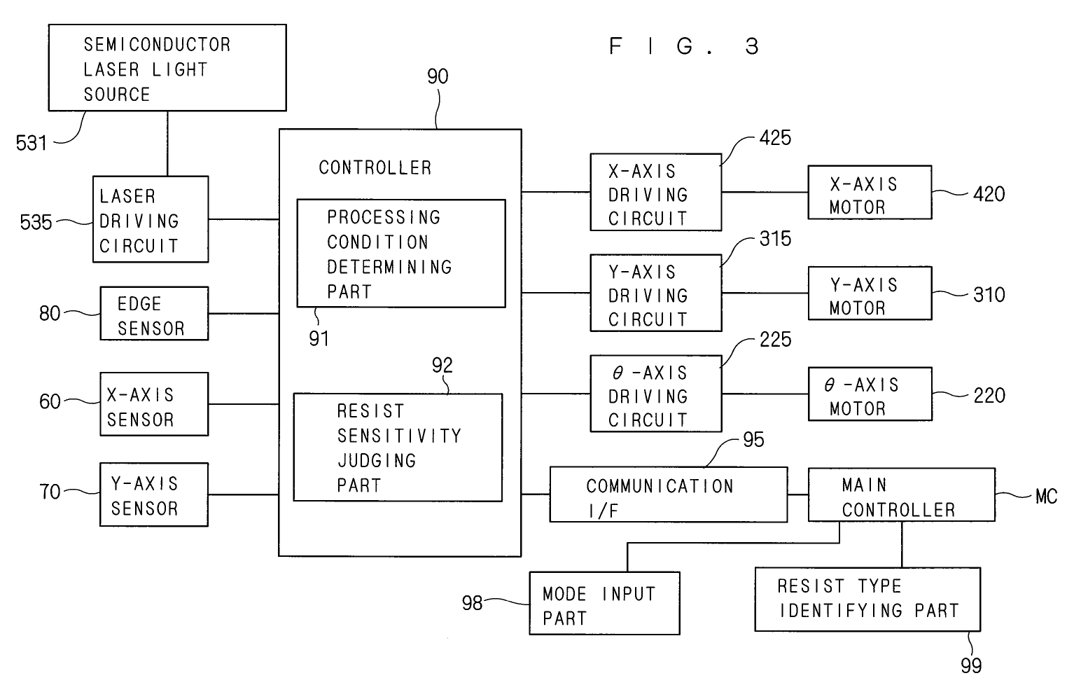

FIG. 3 is a block diagram illustrating the control mechanism of the substrate edge exposure apparatus. The hardware configuration of the controller 90 is identical with that of a general computer. That is, the controller 90 has a CPU performing various arithmetic processing, a ROM that is a read only memory storing a basic program, a RAM that is a random access memory storing various information, a magnetic disk storing an application for control, data, and the like.

A processing condition determining part 91 and a resist sensitivity judging part 92 are processing parts to be realized by the execution of a predetermined processing program by the CPU of the controller 90. The processing contents in the processing condition determining part 91 and the resist sensitivity judging part 92 will be described later.

In addition to the X-axis sensor 60, the Y-axis sensor 70, the edge sensor 80, and the laser driving circuit 535 as described above, an X-axis driving circuit 425 for driving the X-axis motor 420, a Y-axis driving circuit 315 for driving the Y-axis motor 310, and a θ-axis driving circuit 225 for driving the rotary motor 220 are electrically connected to the controller 90. The controller 90 controls these driving circuits based on the results of detections of these sensors, respectively, in order to allow for the movement of the exposure part 50 in the XY plane, the rotation of the semiconductor wafer W held by the vacuum chuck 210, and the laser light emission from the semiconductor laser light source 531.

A communication interface 95 for performing communications with a main controller MC is also connected to the controller 90. In general, the substrate edge exposure apparatus of the first preferred embodiment is often incorporated in a so-called coater & developer. The coater & developer is a substrate processing apparatus, which includes a coater (a spin coater) and a developer (a spin developer) or the like, in addition to the substrate edge exposure apparatus. Specifically, the coater & developer coats a resist on the semiconductor wafer W, and delivers the semiconductor wafer W with a resist film formed thereon, to an exposure unit (a stepper) performing a pattern exposure by using a mask. It then receives the semiconductor wafer W after exposure from the exposure unit, and performs development. The main controller MC is a controller for controlling the coater & developer so configured.

The controller 90 is connected via the communication interface 95 and the main controller MC to a resist type identifying part 99. The resist type identifying part 99 identifies the type of a resist to be coated on the semiconductor wafer W, and it may be constructed by using, for example, a barcode reader that reads the barcode label of a bottle containing a resist. The resist type identifying part 99 may be provided in the coater & developer or the substrate edge exposure apparatus. When the resist type identifying part 99 is provided in the substrate edge exposure apparatus, it is connected directly to the controller 99.

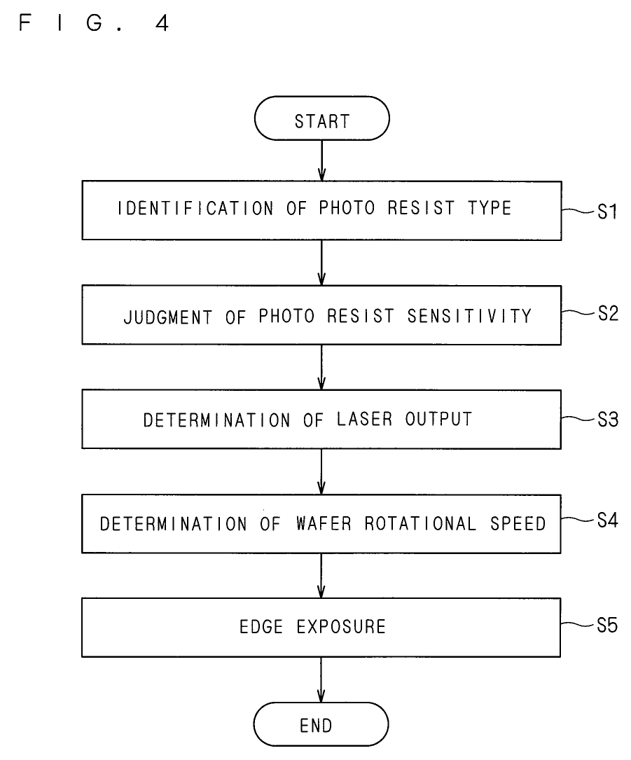

Next, a description will be given of the operation in the substrate edge exposure apparatus having the above-mentioned configuration. FIG. 4 is a flow chart illustrating the operation procedure in the substrate edge exposure apparatus. The basic processing contents of the substrate edge exposure apparatus is the exposure of the edge in the resist film formed on the main surface of the semiconductor wafer W. In the first preferred embodiment, prior to the edge exposure in the substrate edge exposure apparatus, the type of a photo resist coated on the semiconductor wafer W is identified (step S1). The resist type identifying part 99 performs this step. That is, the type of the resist coated on the semiconductor wafer W can be identified by reading the barcode label on the bottle containing the resist. Information about the resist type so identified is then transmitted from the resist type identifying part 99 via the main controller MC and the communication interface 95 to the controller 90. Alternatively, the resist type identifying part 99 may be adapted to identify the type of a resist by referring to a receipt (One in which the procedure and the processing condition of a wafer processing are described.) to be delivered to the above-mentioned coater & developer.

Subsequently, based on the resist type information transmitted from the resist type identifying part 99, the resist sensitivity judging part 92 judges the sensitivity of the resist coated on the semiconductor wafer W (step S2). This step may be performed in the following manner. That is, for example, a table associating the types of resists with their respective sensitivities is stored in a magnetic disk of the controller 90. Based on the above-mentioned resist type information, the resist sensitivity judging part 92 refers to the table, and judges the sensitivity of the resist coated on the semiconductor wafer W.

The procedure then proceeds to steps S3 and S4, which can be performed at substantially the same time. That is, based on the sensitivity of the resist coated on the semiconductor wafer W, the processing condition determining part 91 determines a laser output from the semiconductor laser light source 531 (step S3), and also determines a wafer rotation speed attained by the wafer rotating part 20 (step S4). Here, as the prerequisite under which the processing condition determining part 91 determines the laser output and the wafer rotation speed, the processing time for the edge exposure is preset to the substrate edge exposure apparatus. That is, the substrate edge exposure apparatus is often incorporated in the above-mentioned coater & developer, and the processing time assigned to the edge exposure is preset from the viewpoint of maintaining the throughput of a series of photolithography processing. In the substrate edge exposure apparatus, it is not allowable that the semiconductor wafer W stays over the preset edge exposure time. Therefore, when the processing condition determining part 91 determines the processing condition, of course, it is necessary to determine a laser output and a wafer rotation speed so that the process can be completed within the preset edge exposure time.

The amount of light necessary for exposing a resist film is determined depending on the type of a resist, and the necessary amount of light can be given by the production of an amount of light per unit area and an exposure time. Consequently, for the resist of the same type, in general, the exposure time per unit area is decreased as the wafer rotation speed is increased. It is therefore necessary to increase the laser output. Conversely, the exposure time per unit area is increased as the wafer rotation speed is decreased, and hence the laser output may be low. In either case, the settable ranges of the laser output and the wafer rotation speed are determined from the viewpoints of the standards of semiconductor laser elements and safety. The processing condition determining part 91 is required to determine a laser output and a wafer rotation speed within the corresponding range, respectively.

As the resist sensitivity is decreased, the amount of light necessary for exposing a resist film is increased. Therefore, as the sensitivity of the resist coated on the semiconductor wafer W is decreased, it is necessary to increase the laser output from the semiconductor laser light source 531, or decrease the wafer rotation speed attained by the wafer rotating part 20. Conversely, as the sensitivity of the resist coated on the semiconductor wafer W is increased, the laser output from the semiconductor laser light source 531 may be decreased, and the wafer rotation speed attained by the wafer rotating part 20 may be increased.

Under the above-mentioned different conditions, the processing condition determining part 91 determines the laser output from the semiconductor laser light source 531, and the wafer rotation speed attained by the wafer rotating part 20, based on the resist sensitivity of the semiconductor wafer W judged by the resist sensitivity judging part 92. If the process can be completed within the preset edge exposure time, the laser output value and the water rotation speed value can be set arbitrarily. The following is a specific example.

That is, there may be provided a mode input part 98, which can set and input the mode of the edge exposure to the substrate edge exposure apparatus of the first preferred embodiment or the above-mentioned coater & developer (In the example of FIG. 3, the mode input part 98 is connected to the main controller MC of the coater & developer.). Through the mode input part 98, either a “throughput priority mode” or a “life priority mode” can be selected and inputted. When the “throughput priority mode” is selected, minimizing the time needed in the edge exposure should be the priority, and it is basically set so as to increase both the wafer rotation speed and the laser output. In this case, the processing condition determining part 91 is required to determine the laser output from the semiconductor laser light source 531 at a high value, as the sensitivity of the resist coated on the semiconductor wafer W is lowered. By so doing, even if the resist coated on the semiconductor wafer W has a low sensitivity, the necessary amount of exposure light is ensured by determining the laser output at a high value, without decreasing the wafer rotation speed. This enables a sufficient edge exposure to be performed within a preset edge exposure time.

On the other hand, when the “life priority mode” is selected, increasing the semiconductor laser element life should be the priority, and basically the laser output is minimized and the wafer rotation speed is also decreased. In this case, the processing condition determining part 91 is required to determine the wafer rotation speed attained by the wafer rotating part 20 at a low value, as the sensitivity of the resist coated on the semiconductor wafer W is lowered. Of course, the lower limit of the wafer rotation speed should be the limit to which the process can be completed within a preset edge exposure time. This reduces the load of the semiconductor laser light source 531, enabling the life of the semiconductor laser element to be extended.

After the laser output and the wafer rotation speed are thus determined, the edge exposure is executed according to the determined values thereof (step S5). A specific processing procedure at this time will be described briefly. First, the semiconductor wafer W with the resist coated thereon, which has been loaded from the exterior of the apparatus, is adsorbed and held in its substantially horizontal attitude by the vacuum chuck 210. Referring to the results of detections from the X-axis sensor 60 and the Y-axis sensor 70, the controller 90 transmits control signals to the X-axis driving circuit 425 and the Y-axis driving circuit 315 to drive the X-axis motor 420 and the Y-axis motor 310, respectively, so that the exposure part 50 can be moved to a predetermined exposure position. The term “predetermined exposure position” means a position where the laser irradiated from the exposure head 530 reaches the edge of the semiconductor wafer W held by the vacuum chuck 210.

After the exposure part 50 is moved to the exposure position, the controller 90 transmits a control signal to the θ-axis driving circuit 225 so that the rotary motor 220 can be driven to cause the semiconductor wafer W held by the vacuum chuck 210 to make one complete rotation in a substantially horizontal plane. At this time, the wafer edge position can be stored by receiving a detection signal from the edge sensor 80 while allowing the semiconductor wafer W to rotate. The eccentric amount of the semiconductor wafer W can be recognized from the rotation angle of the semiconductor wafer W, and the wafer edge position.

Subsequently, the controller 90 transmits a control signal to the laser driving circuit 535 so as to cause the semiconductor laser light source 531 to start a laser light irradiation, and transmits a control signal to the θ-axis driving circuit 225 so that the rotary motor 220 is driven to cause the semiconductor wafer W to rotate. At this time, the wafer rotating part 20 rotates the semiconductor wafer W at the wafer rotation speed determined by the processing condition determining part 91, and the laser driving circuit 535 controls the laser output from the semiconductor laser light source 531 to the laser output determined by the processing condition determining part 91. In order to always attain a constant exposure width, the controller 90 makes an eccentric correction by slightly shifting the exposure part 50 as the semiconductor wafer W is rotated, based on the eccentric amount of the semiconductor wafer W which has previously been recognized. Thus, the edge exposure is advanced, and the edge exposure is completed within the preset edge exposure time. After the termination of the edge exposure, the adsorption by the vacuum chuck 210 is released, and the semiconductor wafer W is unloaded.

In the foregoing manner, prior to the edge exposure, the processing condition determining part 91 can determine both of the laser output and the wafer rotation speed based on the sensitivity of the resist coated on the semiconductor wafer W, and the edge exposure can be advanced in accordance with these values. It is therefore capable of flexibly coping with the sensitivity of the resist used. In particular, even if the resist coated on the semiconductor wafer W has a low sensitivity, throughput can be improved by determining the laser output at a high value, and the life of the semiconductor laser element can be extended by determining the wafer rotation speed at a low value.

Additionally, the edge exposure is performed with the laser light from the semiconductor laser light source 531 housing the semiconductor laser element of a long life. This eliminates the necessity for frequent lamp changes, enabling running cost to be suppressed.

### 2. Second Preferred Embodiment

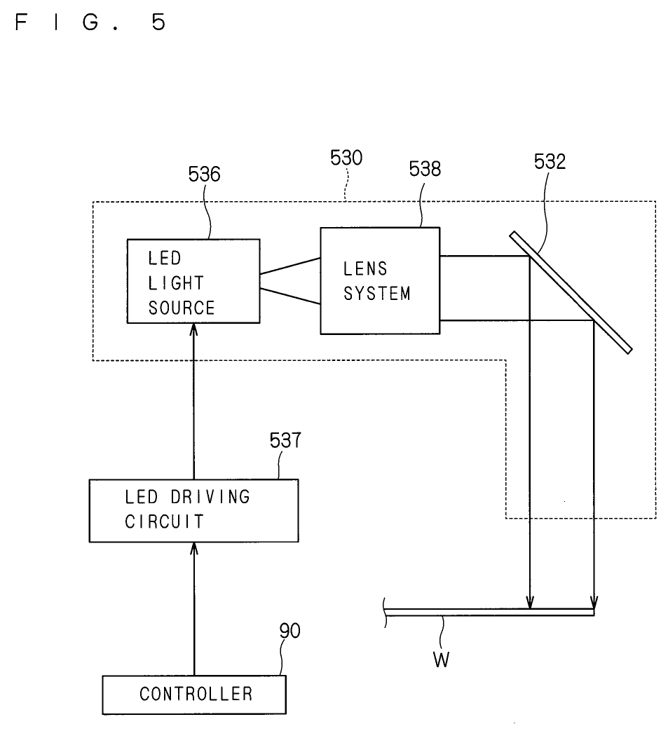

A second preferred embodiment of the present invention will be described below. FIG. 5 is a diagram illustrating an exposure part of a substrate edge exposure apparatus according to the second preferred embodiment. In FIG. 5, like parts as the first preferred embodiment are identified by the same reference numerals. The overall configuration of the substrate edge exposure apparatus of the second preferred embodiment is identical with the first preferred embodiment as illustrated in FIG. 1, except that an LED (light emitting diode) light source 536 is used instead of the semiconductor laser light source 531, as illustrated in FIG. 5.

In the second preferred embodiment, the LED light source 536 has a single light emitting diode. Like the semiconductor laser element in the first preferred embodiment, the light emitting diode has also the characteristic features of a small size, high efficiency, low power consumption, and a long life. Unlike the laser light from the semiconductor laser element, the light emitted from the light emitting diode does not have excellent directivity and hence has the property of spreading. Therefore, an exposure head 530 of the second preferred embodiment has a lens system 538 for condensing the light of the light emitting diode emitted from the LED light source 536. After the light of the light emitting diode emitted from the LED light source 536 is condensed by the lens system 538, it is reflected from a reflector 532 and then irradiated from the exposure head 530 to the edge of a semiconductor wafer W. In the example of FIG. 5, though the lens system 538 is arranged in front of the reflector 532, it may be arranged behind the reflector 532.

An exposure part 50 of the second preferred embodiment is further provided with an LED driving circuit 537 for driving the LED light source 536. On the receipt of an instruction from a controller 90, the LED driving circuit 537 controls the ON/OFF of a light emission from the LED light source 536, and also controls the output of the light.

Otherwise, the configuration of the substrate edge exposure apparatus of the second preferred embodiment is identical to that of the first preferred embodiment. The operation contents and the procedure in the substrate edge exposure apparatus of the second preferred embodiment are also identical with those of the first preferred embodiment. That is, based on the sensitivity of a resist coated on the semiconductor wafer W, the processing condition determining part 91 determines a light output from the LED light source 536, and a wafer rotation speed attained by a wafer rotating part 20. The processes for determining these values are identical with those in the first preferred embodiment. The edge exposure is then executed in accordance with the light output and the wafer rotation speed so determined.

Also in this manner, prior to the edge exposure, the processing condition determining part 91 can determine both of the light output from the LED light source 536 and the wafer rotation speed, based on the sensitivity of the resist coated on the semiconductor wafer W. Thus, the edge exposure can be advanced in accordance with these determined values. It is therefore capable of flexibly coping with the sensitivity of the resist used. In particular, even if the resist coated on the semiconductor wafer W has a low sensitivity, throughput can be improved by determining the light output from the LED light source 536 at a high value, and the life of the light emitting diode can be extended by determining the wafer rotation speed at a low value.

<3. Modifications>

While the preferred embodiments of the present invention have been described above, the invention may be embodied in other specific forms without departing from the spirit. For example, in each of the foregoing embodiments, the resist sensitivity judging part 92 judges the sensitivity of the resist coated on the semiconductor wafer W, based on the result of identification by the resist type identifying part 99. Alternatively, the operator of the apparatus may input the resist sensitivity directly to the controller 90 of the substrate edge exposure apparatus.

In each of the foregoing embodiments, the edge exposure is executed by rotating the semiconductor wafer W while irradiating thereto the light from the exposure part 50. Alternatively, the edge exposure may be executed, with the semiconductor wafer W fixed, by shifting the exposure part 50 for irradiating light along the edge of the semiconductor wafer W. In other words, the exposure part 50 may be moved relative to the edge of the semiconductor wafer W.

It should be understood that the substrate edge exposure apparatus according to the present invention may handle, for example, glass substrates for liquid crystal display units, without limiting to semiconductor wafers.

While the invention has been shown and described in detail, the foregoing description is in all aspects illustrative and not restrictive. It is therefore understood that numerous modifications and variations can be devised without departing from the scope of the invention.

What is claimed is:

1. A substrate edge exposure apparatus for exposing an edge of a substrate with a photo resist coated thereon, comprising:
a holding and rotating part for holding and rotating a substrate in a substantially horizontal plane;
a semiconductor laser light source for irradiating a laser light to an edge of said substrate rotated by said holding and rotating part;
a processing condition determining part for determining a laser output from said semiconductor laser light source and a substrate rotation speed attained by said holding and rotating part, based on a sensitivity of a photo resist coated on said substrate;
a rotation control part for controlling said holding and rotating part so that said substrate can be rotated at the substrate rotation speed determined by said processing condition determining part; and
an output control part for controlling said semiconductor laser light source so that a laser light can be emitted according to the laser output determined by said processing condition determining part.

2. The substrate edge exposure apparatus according to claim 1, further comprising:
a resist type identifying part for identifying a type of said photo resist to be coated on said substrate; and
a resist sensitivity judging part for judging a sensitivity of said photo resist from the type of said photo resist identified by said resist type identifying part.

3. The substrate edge exposure apparatus according to claim 1, wherein said processing condition determining part determines a laser output from said semiconductor laser light source and a substrate rotation speed attained by said holding and rotating part, so that a process can be completed within a preset edge exposure time.

4. The substrate edge exposure apparatus according to claim 3, wherein said processing condition determining part determines a laser output from said semiconductor laser light source at a high value, as said sensitivity of said photo resist coated on said substrate is lowered.

5. The substrate edge exposure apparatus according to claim 3, wherein said processing condition determining part determines a substrate rotation speed attained by said holding and rotating part at a low value, as said sensitivity of said photo resist coated on said substrate is lowered.

6. The substrate edge exposure apparatus according to claim 3, further comprising:
a mode input part for inputting a throughput priority mode or a life priority mode as a mode of edge exposure, wherein,
when the throughput priority mode is selected, said processing condition determining part determines a laser output from said semiconductor laser light source at a high value, as said sensitivity of said photo resist coated on said substrate is lowered; and when the life priority mode is selected, said processing condition determining part determines a substrate rotation speed attained by said holding and rotating part at a low value, as said sensitivity of said photo resist coated on said substrate is lowered.

7. A substrate edge exposure apparatus for exposing an edge of a substrate with a photo resist coated thereon, comprising:
a holding and rotating part for holding and rotating a substrate in a substantially horizontal plane;
a light emitting diode light source for irradiating a light to an edge of said substrate rotated by said holding and rotating part;
a processing condition determining part for determining, based on a sensitivity of a photo resist coated on said substrate, a light output from said light emitting diode light source and a substrate rotation speed attained by said holding and rotating part;
a rotation control part for controlling said holding and rotating part so that said substrate can be rotated at the substrate rotation speed determined by said processing condition determining part; and
an output control part for controlling said light emitting diode light source so that a light can be emitted according to the light output determined by said processing condition determining part.

8. The substrate edge exposure apparatus according to claim 7, further comprising:
a resist type identifying part for identifying a type of said photo resist coated on said substrate; and
a resist sensitivity judging part for judging a sensitivity of said photo resist from the type of said photo resist identified by said resist type identifying part.

9. The substrate edge exposure apparatus according to claim 7, wherein said processing condition determining part determines a light output from said light emitting diode light source and a substrate rotation speed attained by said holding and rotating part, so that a process can be completed within a preset edge exposure time.

10. The substrate edge exposure apparatus according to claim 9, wherein said processing condition determining part determines a light output from said light emitting diode light source at a high value, as said sensitivity of said photo resist coated on said substrate is lowered.

11. The substrate edge exposure apparatus according to claim 9, wherein said processing condition determining part determines a substrate rotation speed attained by said holding and rotating part at a low value, as said sensitivity of said photo resist coated on said substrate is lowered.

12. The substrate edge exposure apparatus according to claim 9, further comprising:
a mode input part for inputting a throughput priority mode or a life priority mode as a mode of edge exposure, wherein,
when the throughput priority mode is selected, said processing condition determining part determines a light output from said light emitting diode light source at a high value, as said sensitivity of said photo resist coated on said substrate is lowered; and when the life priority mode is selected, said processing condition determining part determines a substrate rotation speed attained by said holding and rotating part at a low value, as said sensitivity of said photo resist coated on said substrate is lowered.
